(19) United States
(12) Patent Application Publication
(10) Pub. No.: US 2024/0172582 A1
(43) Pub. Date: May 30, 2024

(54) Methods and Systems for Detecting Damage to Agricultural Implements

(71) Applicant: AGCO Corporation, Duluth, GA (US)

(72) Inventors: Allen J. Kuhn, Hesston, KS (US); Rex Schertz, Hesston, KS (US); Michael B. Bayliff, Hesston, KS (US)

(21) Appl. No.: 18/551,801

(22) PCT Filed: Mar. 30, 2022
(86) PCT No.: PCT/IB2022/052936

§ 371 Date: Sep. 21, 2023

Related U.S. Application Data
(60) Provisional application No. 63/179,609, filed on Apr. 26, 2021.

(51) Int. Cl. A01B 79/00; A01B 63/00; G06T 7/00

(52) U.S. Cl. CPC A01B 79/005; A01B 63/008; G06T 7/0002; G06T 2200/04; G06T 2207/10028; G06T 2207/30164; G06T 2207/30252

(57) ABSTRACT

An agricultural machine includes a body configured to traverse a field, the body carrying tillage elements configured to engage soil. At least one lift element is configured to raise the tillage elements above ground. A sensor is configured to detect a position of tillage elements above the ground. A computing device is configured to compare the detected position to a reference to detect damage to the agricultural machine. A method includes generating a first representation of tillage elements, traversing a field with the tillage elements engaging soil of the field, raising the tillage elements above ground to disengage the soil of the field, generating a second representation of the tillage elements while the tillage elements are above the ground, and comparing the second representation to the first representation to detect damage to the agricultural implement. Generating and comparing the representations are performed by at least one computing device.

### CROSS-REFERENCE TO RELATED APPLICATION

This application claims the benefit of the filing date of U.S. Provisional Patent Application 63/179,609, “Methods and Systems for Detecting Damage to Agricultural Implements,” filed Apr. 26, 2021, the entire disclosure of which is incorporated herein by reference.

### FIELD

Embodiments of the present disclosure relate generally to agricultural machines and methods for operating such machines. In particular, the machines and methods may be used to detect damage to the machines.

### BACKGROUND

Tillage implements are machines that are typically towed behind tractors to condition soil for improved moisture distribution. Tillage implements include ground-engaging tools such as shanks, tillage points, discs, etc.

In a typical agricultural tillage operation, monitoring the health and function of the machine while the tools are engaged with the ground can be challenging. In some conditions, it is almost impossible to monitor the health of the machine while tools are engaged with the ground. Soil and crop residue can be thrown, which obscures vision, and dust can create a cloud that further limits visibility. In autonomous agricultural tillage operations, these challenges of supervision while engaged with the ground may limit the effectiveness of sensors designed to assess the health and function of the tillage machine.

### BRIEF SUMMARY

In some embodiments, a method of operating an agricultural machine includes generating a first representation of tillage elements of an agricultural implement, traversing a field with the tillage elements engaging soil of the field, raising the tillage elements above ground to disengage the soil of the field, generating a second representation of the tillage elements while the tillage elements are above the ground, and comparing the second representation to the first representation to detect damage to the agricultural implement. Generating and comparing the representations are performed by at least one computing device.

In some embodiments, an agricultural machine includes a body configured to traverse a field, the body carrying a plurality of tillage elements configured to engage soil. At least one lift element is configured to raise the tillage elements above ground. At least one sensor is configured to detect a position of at least one tillage element of the plurality while the tillage elements are above the ground. At least one computing device is configured to compare the detected position to a reference to detect damage to the agricultural machine.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified top view of a tractor drawing an agricultural implement;

FIG. 2 is a simplified cross-sectional side view of the agricultural implement shown in FIG. 1 in a lowered position, with the implement engaging the field;

FIG. 3 is a simplified cross-sectional side view of the agricultural implement shown in FIG. 1 in a raised position;

FIG. 4 is a simplified flow chart illustrating a method of using the tractor and implement; and

FIG. 5 illustrates an example computer-readable storage medium comprising processor-executable instructions configured to embody one or more methods of using an implement, such as the method illustrated in FIG. 4.

### DETAILED DESCRIPTION

The illustrations presented herein are not actual views of any tractor, tillage implement, or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

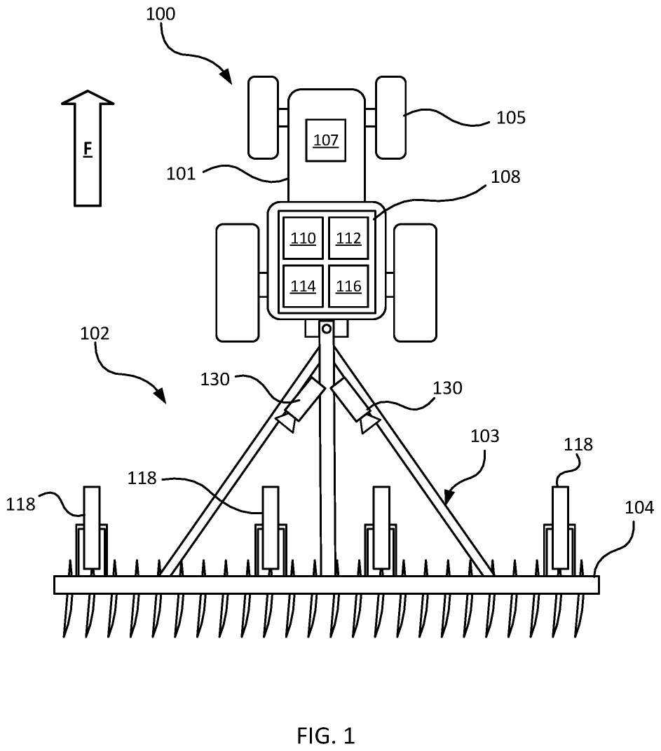

FIG. 1 is a simplified top view of an agricultural machine in the form of a tractor 100 drawing an agricultural implement 102. The tractor 100 includes a chassis 101 supported by ground-engaging supports 105 (typically wheels and/or tracks). The tractor 100 has a prime mover 107 (e.g., an internal combustion engine, an electric motor, a fuel cell, etc.) to drive at least one of the supports 105 and propel the tractor 100 in a direction F through a field. A computer 108, which may include a central processing unit (“CPU”) 110, memory 112, implement controller 114, and graphical user interface (“GUI”) (e.g., a touch-screen interface), is typically located in a cab of the tractor 100. A global positioning system (“GPS”) receiver 116 may be mounted to the tractor 100 and connected to communicate with the computer 108. The computer 108 may include an implement controller 114 configured to communicate with the implement 102 and/or the GPS receiver 116, such as by wired or wireless communication. In some embodiments, the tractor 100 may be an autonomous machine, and the cab may be omitted. In those embodiments, the computer 108 may operate the tractor 100 independently, or may receive instructions from a remote operator or system via a wireless link.

The implement 102 has a body including a frame 103 and a toolbar 104 supporting tillage elements 106. The implement 102 may be supported in the field by at least one wheel 118 coupled to the toolbar 104. Typically, the toolbar 104 is attached to at least two wheels 118, such as to four wheels as shown in FIG. 1.

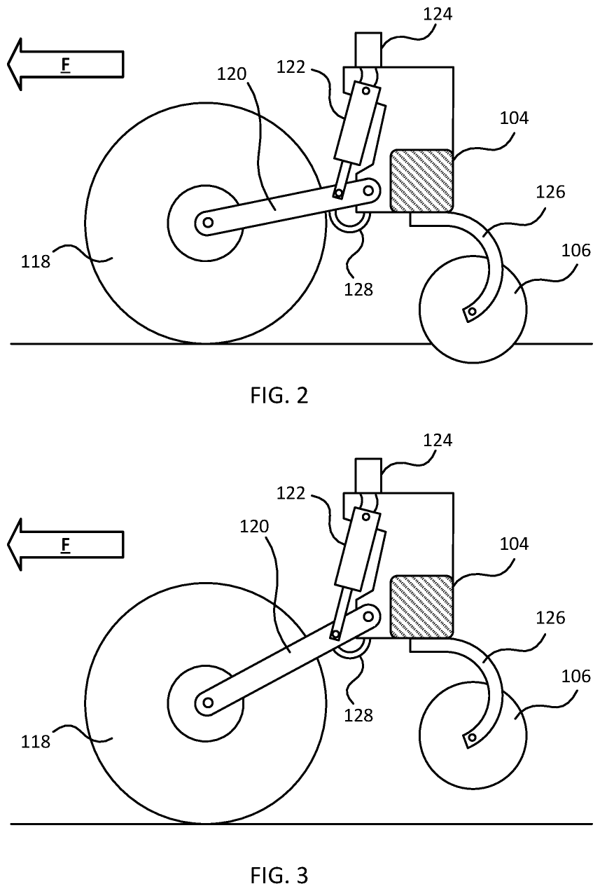

FIG. 2 is a simplified side view of a portion of the implement 102. One of the wheels 118 is shown coupled to an adjustable arm 120 configured to change the height of the toolbar 104 above the ground. A lift element 122 may raise and lower the toolbar 104 relative to the wheel 118. The lift element 122 may be connected to a controller 124 that controls the lift element 122. The controller 124 may include, for example a valve, an electronic signal generator, etc. The controller 124 may be or include a signal transmitter configured to communicate with the computer 108, such as by a wired or wireless link. For example, the controller 124 may communicate the position of the lift element 122 to the computer 108, and may receive a signal from the computer 108 to change the position of the lift element 122. One of the tillage elements 106 is shown coupled to the toolbar 104 by a hanger or bracket 126. Though depicted as a tillage disc, the tillage element 106 may be of any selected design, such as a shank, a cultivator sweep, a knife, etc.

FIG. 3 is a simplified side view of the implement 102 after the lift element 122 has lifted the tillage elements 106 above the ground. One or more lift sensor(s) 128 may measure the position of the toolbar 104 relative to the wheel 118 (e.g., by measuring an angle between the adjustable arm 120 and the toolbar 104, as shown, or by using radar, ultrasonic, lidar, etc.), and may communicate that position to the controller 124 and/or the computer 108.

Returning to FIG. 1, the implement 102 may carry one or more sensors 130 configured to detect the position of the tillage elements 106 carried by the toolbar 104. In other embodiments the sensors 130 may be carried by the tractor 100. The sensors 130 may include, for example, cameras or distance sensors (e.g., lidar transceivers). The sensors 130 may transmit a signal to the computer 108 indicating the detected position of the tillage elements 106. For example, the sensors 130 may transmit an image or a 3-dimensional point cloud representing the tillage elements 106 to the computer 108. In some embodiments, the position of the tillage elements 106 may include the position of one or more individual points on the tillage elements 106 (e.g., the centers of the tillage elements). The computer 108 may be configured to detect damage to the implement 102 by comparing the detected positions of the tillage elements 106 to a reference that includes expected positions of the tillage elements 106.

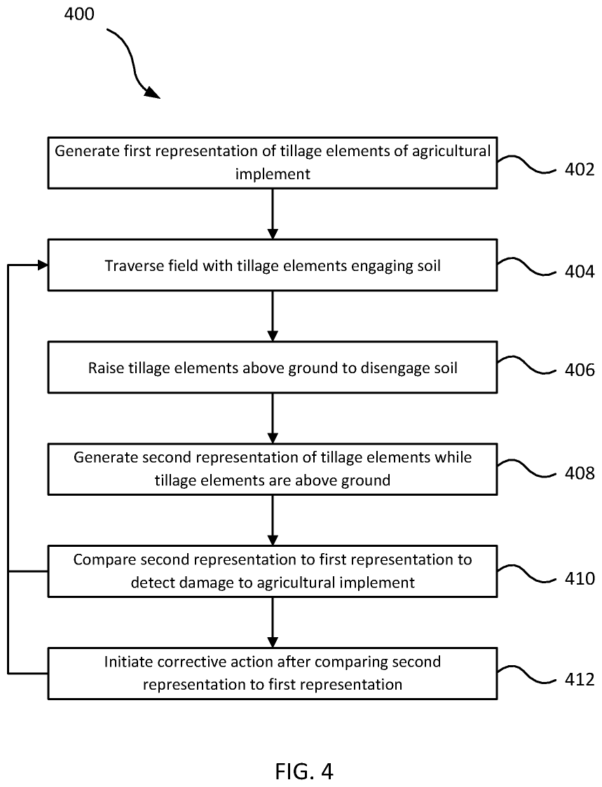

FIG. 4 is a simplified flow chart illustrating a method 400 of using the tractor 100 and implement 102 shown in FIG. 1. In block 402, a first representation of tillage elements 106 of an agricultural implement is generated by at least one computing device. The representation may be an image or a 3-dimensional point cloud having points corresponding to the exterior surfaces of the tillage elements. For example, a point cloud can be generated as described in U.S. Pat. No. 10,401,866, “Methods and Systems for Lidar Point Cloud Anomalies,” granted Sep. 3, 2019; and U.S. Pat. No. 10,832,334, “Assessing Property Damage Using a 3D Point Cloud of a Scanned Property,” granted Nov. 10, 2020. The first representation may be generated at a time when the agricultural implement is known to operate as designed, such as before being used to work a field (i.e., as delivered by a factory). In some embodiments, the first representation may be generated after the agricultural implement has been used to work a field. The first representation may be generated more than once, such as once per season, once per day, or after a repair. The first representation may include representations of the shapes and/or positions of the tillage elements. The first representation may be generated based on data from the sensor(s) 130 (FIG. 1) while the tillage elements 106 are above ground (e.g., as shown in FIG. 3).

Block 404 represents traversing a field with the tillage elements engaging soil of the field (i.e., lowered into contact with the soil). In some embodiments, the field may be traversed by an autonomous agricultural machine, without a human operator on board.

Block 406 represents raising the tillage elements above ground to disengage the soil of the field, such as depicted in FIG. 3. This is typically performed at the headlands while turning the machine around to go back for another pass through the field, though the tillage elements could be raised above ground at any point. For example, if damage is suspected, tillage could be paused mid-field.

In block 408, the computing device generates a second representation of the tillage elements while the tillage elements are above the ground. The second representation may be generated in similar manner to generation of the first representation, depicted in block 402 and described above.

In block 410, the computing device compares the second representation to the first representation to detect damage to the agricultural implement. For example, the computing device may determine a distance between an identified point on one of the tillage elements (e.g., a center of a disc, a point of knife, etc.) in the second representation and that same identified point on that tillage element in the first representation. The computing device may determine whether the tillage elements are displaced from their expected locations. This may help to detect missing or broken components, proper location of tillage elements, failed linkages, frame failures, improper lift, impact damage, sudden structural failures, incipient structural failures, or plastic deformation of the agricultural implement. For example, a comparison of the raised position of the tillage elements could be used to detect proper operation of the lift elements 122.

In block 412, when the second representation is different from the first representation by a predefined threshold, the computing device initiates a corrective action after comparing the second representation to the first representation. The corrective action may be associated with preventing further damage to the agricultural implement or to the field. For example, the computing device may reduce a ground speed of the agricultural machine, stop the agricultural machine, or provide a notification to an operator or a supervisor of the agricultural machine (e.g., a person or machine that can take control of the machine as needed). In some embodiments, the corrective action may be used to maintain the tillage elements at a selected depth in the field, or to maintain at least one of the tillage elements above the ground (e.g., to prevent further damage to that tillage element).

Though depicted as a flow chart, the actions in FIG. 4 may be performed concurrently, and in some embodiments, some actions may be omitted. For example, blocks 404 through 410 or 404 through 412 may be repeated throughout a tillage operation, such as at the end of each pass through a field (i.e., while turning in the headlands).

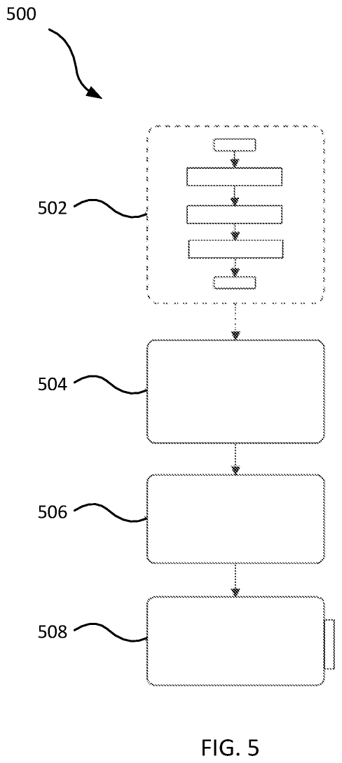

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 5, wherein an implementation 500 includes a computer-readable storage medium 502 (e.g., a flash drive, CD-R, DVD-R, application-specific integrated circuit (ASIC), field-programmable gate array (FPGA), a platter of a hard disk drive, etc.), on which is computer-readable data 504. This computer-readable data 504 in turn includes a set of processor-executable instructions 506 configured to operate according to one or more of the principles set forth herein. In some embodiments, the processor-executable instructions 506 may be configured to cause the computer 108 associated with the tractor 100 (FIG. 1) to perform operations 508 when executed via a processing unit, such as at least some of the example method 400 depicted in FIG. 4. In other embodiments, the processor-executable instructions 506 may be configured to implement a system, such as at least some of the example tractor 100 and implement 102 depicted in FIG. 1. Many such computer-readable media may be devised by those of ordinary skill in the art that are configured to operate in accordance with one or more of the techniques presented herein.

Additional non-limiting example embodiments of the disclosure are described below.
Embodiment 1: A method of operating an agricultural machine, the method comprising generating a first representation of tillage elements of an agricultural implement, traversing a field with the tillage elements engaging soil of the field, raising the tillage elements above ground to disengage the soil of the field, generating a second representation of the tillage elements while the tillage elements are above the ground, and comparing the second representation to the first representation to detect damage to the agricultural implement. Generating and comparing the representations are performed by at least one computing device.
Embodiment 2: The method of Embodiment 1, wherein the first representation and the second representation each comprise representations selected from the group consisting of images and 3-dimensional point clouds.
Embodiment 3: The method of Embodiment 1 or Embodiment 2, wherein generating a first representation comprises generating the first representation when the agricultural implement is known to operate as designed.
Embodiment 4: The method of any one of Embodiment 1 through Embodiment 3, wherein generating a first representation comprises generating the first representation after the agricultural implement has been used to work a field.
Embodiment 5: The method of any one of Embodiment 1 through Embodiment 4, wherein the first representation and the second representation each comprise representations of a shape of the tillage elements.
Embodiment 6: The method of any one of Embodiment 1 through Embodiment 5, wherein the first representation and the second representation each comprise representations of positions of the tillage elements.
Embodiment 7: The method of any one of Embodiment 1 through Embodiment 6, further comprising initiating a corrective action by the at least one computing device after comparing the second representation to the first representation.
Embodiment 8: The method of Embodiment 7, wherein the corrective action is associated with preventing further damage to the agricultural implement.
Embodiment 9: The method of Embodiment 7 or Embodiment 8, wherein the corrective action is associated with preventing damage to the field.
Embodiment 10: The method of any one of Embodiment 7 through Embodiment 9, wherein initiating a corrective action comprises reducing a ground speed of the agricultural machine.
Embodiment 11: The method of any one of Embodiment 7 through Embodiment 10, wherein initiating a corrective action comprises stopping the agricultural machine.
Embodiment 12: The method of any one of Embodiment 7 through Embodiment 10, wherein the corrective action is associated with maintaining the tillage elements at a selected depth in the field.
Embodiment 13: The method of any one of Embodiment 7 through Embodiment 12, wherein initiating a corrective action comprises maintaining at least one of the tillage elements above the ground.
Embodiment 14: The method of any one of Embodiment 7 through Embodiment 13, wherein initiating a corrective action comprises providing a notification to at least one of an operator or a supervisor of the agricultural machine.
Embodiment 15: The method of any one of Embodiment 1 through Embodiment 14, wherein comparing the second representation to the first representation comprises determining a distance between an identified point on at least one of the tillage elements in the second representation and the identified point on the at least one of the tillage elements in the first representation.
Embodiment 16: The method of any one of Embodiment 1 through Embodiment 15, wherein comparing the second representation to the first representation comprises determining whether at least one of the tillage elements is displaced from an expected location.
Embodiment 17: The method of any one of Embodiment 1 through Embodiment 16, wherein traversing a field with an agricultural machine comprises traversing a field with an autonomous agricultural machine.
Embodiment 18: An agricultural machine, comprising a body configured to traverse a field, the body carrying a plurality of tillage elements configured to engage soil. At least one lift element is configured to raise the tillage elements above ground. At least one sensor is configured to detect at least one tillage element of the plurality while the tillage elements are above the ground. At least one computing device is configured to compare the detected tillage element to a reference to detect damage to the agricultural machine.
Embodiment 19: The agricultural machine of Embodiment 18, wherein the body comprises a chassis, a plurality of ground-engaging supports supporting the chassis, and a prime mover configured to drive at least some of the ground-engaging supports.
Embodiment 20: The agricultural machine of Embodiment 18 or Embodiment 19, wherein the agricultural machine is an autonomous machine.
Embodiment 21: The agricultural machine of Embodiment 20, further comprising a signal transmitter configured to enable the at least one computing device to communicate with a remote computing system over at least one wireless link.
Embodiment 22: The agricultural machine of any one of Embodiment 18 through Embodiment 20, further comprising a signal transmitter configured to enable the at least one sensor to communicate with the at least one computing device over at least one wireless link.
Embodiment 23: The agricultural machine of any one of Embodiment 18 through Embodiment 22, wherein the at least one computing device is configured to generate a representation of the tillage elements using information from the at least one sensor when the tillage elements are above ground.
Embodiment 24: The agricultural machine of Embodiment 23, wherein the representation of the tillage elements is selected from the group consisting of an image and a 3-dimensional point cloud.
Embodiment 25: The agricultural machine of any one of Embodiment 18 through Embodiment 24, wherein the at least one sensor comprises a camera.
Embodiment 26: The agricultural machine of any one of Embodiment 18 through Embodiment 25, wherein the at least one sensor comprises a distance sensor.
Embodiment 27: The agricultural machine of any one of Embodiment 18 through Embodiment 26, wherein the at least one sensor is configured to detect at least one of a shape or a position of the at least one tillage element.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A method of operating an agricultural machine, the method comprising:
generating a first representation of tools carried by an implement, by at least one computing device based on data from a sensor, wherein the sensor is carried by the implement;
traversing a field with the implement with the tools engaging soil of the field;
raising the tools above ground to disengage the soil of the field;
generating a second representation of tools carried by the implement, by the at least one computing device, while the tools are above the ground; and
comparing, by the at least one computing device, the second representation to the first representation to detect damage to the implement.

2. The method of claim 1, wherein the first representation and the second representation each comprise representations selected from the group consisting of images and 3-dimensional point clouds.

3. The method of claim 1, wherein generating a first representation comprises generating the first representation when the implement is known to operate as designed.

4. The method of claim 1, wherein generating a first representation comprises generating the first representation after the implement has been used to work a field.

5. The method of claim 1, wherein the first representation and the second representation each comprise representations of a shape of the tools.

6. The method of claim 1, wherein the first representation and the second representation each comprise representations of positions of the tools.

7. The method of claim 1, further comprising initiating a corrective action by the at least one computing device after comparing the second representation to the first representation.

8. The method of claim 7, wherein the corrective action is associated with preventing further damage to the implement.

9. The method of claim 7, wherein the corrective action is associated with preventing damage to the field.

10. The method of claim 7, wherein initiating a corrective action comprises reducing a ground speed of the agricultural machine.

11. The method of claim 7, wherein initiating a corrective action comprises stopping the agricultural machine.

12. The method of claim 7, wherein the corrective action is associated with maintaining the tools at a selected depth in the field.

13. The method of claim 7, wherein initiating a corrective action comprises maintaining at least one of the tools above the ground.

14. The method of claim 7, wherein initiating a corrective action comprises providing a notification to at least one of an operator or a supervisor of the agricultural machine.

15.-17. (canceled)

18. An agricultural implement comprising:
a body configured to traverse a field, the body carrying a plurality of tools configured to engage soil;
at least one lift element configured to raise the tools above ground;
at least one sensor carried by the body and configured to detect at least one tool of the plurality while the tools are above the ground; and
at least one computing device configured to compare the detected tools to a reference to detect damage to the implement.

19.-22. (canceled)

23. The agricultural implement of claim 18, wherein the at least one computing device is configured to generate a representation of the tools using information from the at least one sensor when the tools are above ground.

24. The agricultural implement of claim 23, wherein the representation of the tools is selected from the group consisting of an image and a 3-dimensional point cloud.

25. The agricultural implement of claim 18, wherein the at least one sensor comprises a camera.

26. The agricultural implement of claim 18, wherein the at least one sensor comprises a distance sensor.

27. The agricultural implement of claim 18, wherein the at least one sensor is configured to detect at least one of a shape or a position of the at least one tool.
